(19) United States
(12) Patent Application Publication
(10) Pub. No.: US 2016/0006160 A1
(43) Pub. Date: Jan. 7, 2016

(54) SEALED CONNECTOR AND METHOD OF SEALING A CONNECTOR

(71) Applicant: Electronic Motion Systems Holding Limited, Maidenhead (GB)

(72) Inventors: Jonathan Rhodes, Aberdulais (GB); Mark Jones, Llanelli (GB); Peter Sommerfeld, Essen (DE)

(21) Appl. No.: 14/789,481

(22) Filed: Jul. 1, 2015

Related U.S. Application Data
(60) Provisional application No. 62/020,667, filed on Jul. 3, 2014.

(51) Int. Cl. H01R 13/52; B29C 45/14; H01R 43/16

(52) U.S. Cl. CPC H01R 13/5202; H01R 43/16; B29C 45/14336; B29C 2045/14459; B29L 2031/3481

(57) ABSTRACT

A sealed insert molded connector and method of sealing the same includes one or more inserts molded into a housing so that at least one portion of the insert extends through the housing. A bonding region is formed at the point where the insert extends through the housing. The conformal coating or sealing material is applied to the bonding region where the molded housing forms the insert creating a moisture resistant seal between the housing and the insert. The viscosity of the sealing material is chosen so that the sealing material exhibits minimum travel under the influence of gravity. A collar forming a moat or well around the bonding agent may be formed.

### CROSS-REFERENCE TO RELATED APPLICATIONS

This application claims priority of U.S. Provisional Application 62/020,667 filed Jul. 3, 2014, the contents of which are incorporated herein by reference.

### FIELD OF THE INVENTION

The present invention relates generally to connectors and, more particularly, to sealed insert molded connectors.

### BACKGROUND OF THE INVENTION

Insert molding is a known process for creating custom connectors commonly used in electronic enclosures, such as for automotive applications. The process involves combining discrete parts such as metal leadframes and other inserts into a single component by injecting a thermoplastic around the inserts. The insert molding process provides greater design flexibility and is an efficient alternative to assembling discrete components.

### SUMMARY OF THE INVENTION

The present invention provides a sealed insert molded connector and method of sealing the same. The connector includes one or more inserts molded into a housing so that at least one portion of the insert extends through the housing. A conformal coating or sealing material is applied to a bonding region where the molded housing forms to the insert, creating a moisture resistant seal between the housing and the insert. The viscosity of the sealing material may be chosen so that the sealing material exhibits minimal travel under the influence of gravity, allowing the sealing material to remain substantially at the region of application during the curing process. Optionally, the housing may include recessed collars around the bonding region, forming moats or wells, for the sealing material to collect, where the collars may be formed in the plastic of the housing to form a wall or walls adjacent to and surrounding a leadframe.

These and other objects, advantages, purposes and features of the present invention will become more apparent upon review of the following specification in conjunction with the drawings.

### BRIEF DESCRIPTION OF THE DRAWINGS

FIG. 1 is a perspective view of an electronics enclosure cover incorporating a sealed insert molded connector in accordance with the present invention;

FIG. 2 is a perspective view of the sealed insert molded connector of FIG. 1;

FIG. 3 is a perspective view of the inserts or leadframes used in the sealed insert molded connector of FIG. 2 prior to the plastic housing being injection molded there about;

FIG. 4 is a partial perspective view of a portion of a molded housing having a recessed collar disposed around an insert; and

FIG. 5 is a partial perspective view of the portion of the molded housing with the conformal sealing material disposed therein.

### DETAILED DESCRIPTION OF THE PREFERRED EMBODIMENTS

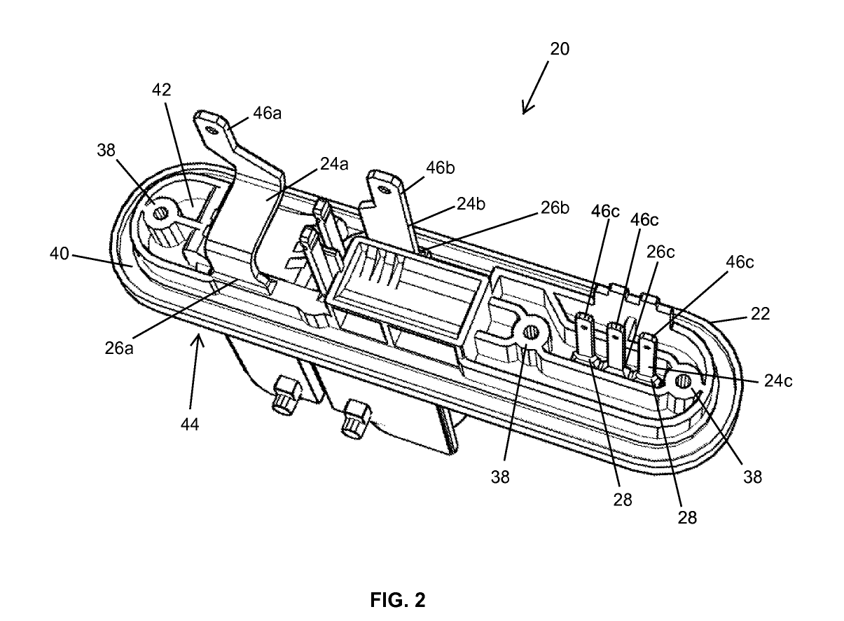

Referring now to the drawings and the illustrative embodiments depicted therein, a sealed insert molded connector 20 includes a casing or housing 22 molded around conductive leadframes or inserts 24a, 24b, and 24c. (FIG. 2) When housing 22 is molded about metal inserts 24a-24c at least a portion of inserts 24a-24c protrudes from housing 22, forming bonding regions or joints 26a, 26b, and 26c at which inserts 24a-24c, respectively, exit or protrude from housing 22. A conformal coating or sealing material 28 is applied around the bonding regions to create a moisture resistant seal at the junction of housing 22 and inserts 24a-24c. The conformal coating sealing material 28 is provided with a viscosity sufficient to inhibit its flow under influence of gravity to thereby enable the controlled application of the sealing material 28 and handling of connector 20 during the manufacturing and assembly process, such as during the curing process and assembly of the connector 20 to an electronic assembly. This allows sealing material 28 to be applied only where it is needed to perform the sealing function. Optionally, the sealing function may be further enhanced by creating collars or moats in housing 22 around the bonding regions 26a-26c to form an area for sealing material 28 to collect. Additionally, a vacuum pressure (or reduced pressure c.f. atmospheric pressure) may be applied to the underside of connector 20 to help draw sealing material 28 into the interface between molded housing 22 and inserts 24a-24c at the bonding regions 26a-26c.

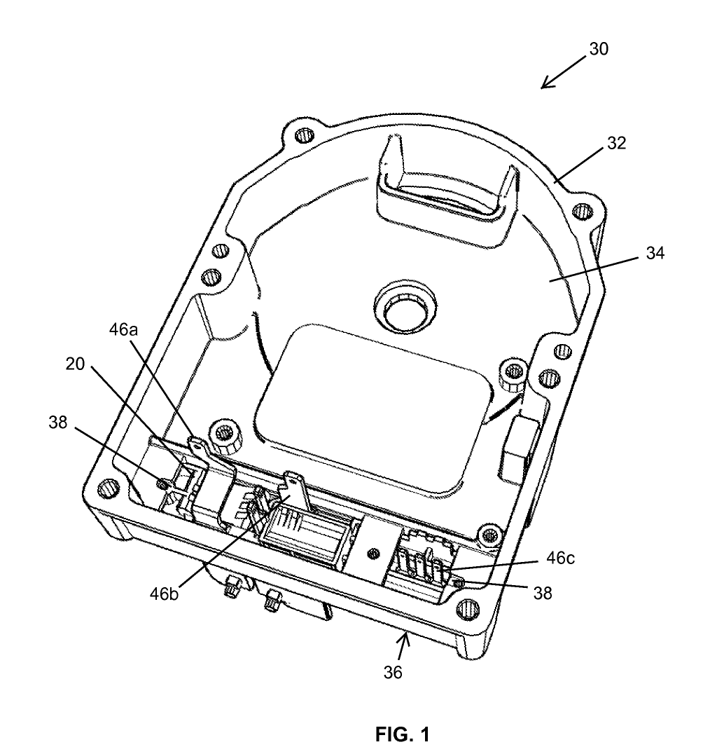

FIG. 1 shows an example of a cover assembly 30 for an electronics enclosure incorporating sealed insert molded connector 20. Cover assembly 30 includes a cover portion 32 having an inner surface 34 and an outer surface 36 and is configured to attach to another portion to provide a moisture resistant enclosure for an electronics assembly, such as a printed circuit board (PCB) to which connector 20 engages. Connector 20 may fasten to cover 32 via one or more mounting posts 38 and may also receive a gasket within groove 40 disposed about the perimeter of housing 22 to prevent the ingress of moisture in the region where connector 20 and cover 32 meet (FIG. 2).

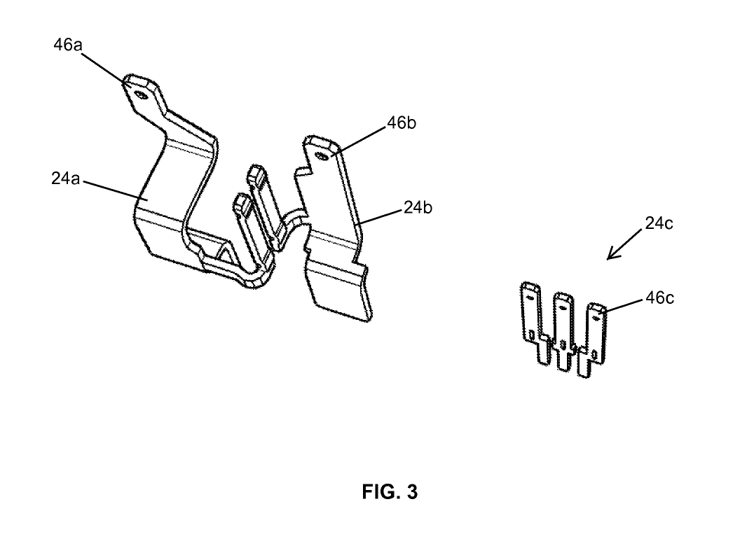

Molded into housing 22 of connector 20 are inserts 24a-c, which extend through housing 22 and are configured to provide an electrical connection between the electronics assembly enclosed by cover 32 and an external source providing power, data or the like. As best shown in FIG. 3, inserts 24a-24c include tabs 46a, 46b, and 46c, respectively. When molded into housing 22, tabs 46a-46c extend or protrude from an inner side or surface 42 of housing 22, where inner side 42 defines an electronics-side of the connector for connecting to an electronic assembly, and inserts 24a-24c form interface of bonding regions 26a-26c where the housing material forms to the respective insert. (FIG. 2) That is, the bonding regions 26a-26c define the joint between the material of the housing 22 and inserts 24a-24c that is created or formed during the process of molding housing 22 about inserts 24a-24c.

Because housing 22 is formed from a plastic material and inserts 24a-24c are typically formed from metal or other conductive material, the adhesion between the two materials is insufficient to provide a proper barrier from moisture ingress. To provide proper protection against moisture ingress, therefore, a secondary sealing process involving the application of conformal coating sealing material 28 to bonding regions 26a-26c is used. Conformal coating 28 adheres to both inner surface 42 of housing 22 and inserts 24a-24c forming a moisture resistant barrier, such as by blocking the joint between housing 22 and inserts 24a-24c at bonding regions 26a-26c. FIG. 2 discloses conformal coating sealing material 28 disposed about two leadframes 46c for illustrative purposes, where the conformal coating sealing material 28 forms a bead around the leadframes 46c and is in contact with the leadframes 46c and housing 22. It should be appreciated that conformal coating sealing material 28 may be disposed about each leadframe, including leadframes 46a and 46b, at the bonding regions 26a-26c.

The viscous properties of conformal coating sealing material 28 are chosen so that the conformal coating 28 is sufficiently resistant to flow by gravitational forces and, therefore, remains generally in the region in which it was applied during the subsequent processing, handling, and assembly of connector 20 and curing of conformal coating 28. Thus, the volume of material required to seal connector 20 is reduced because only a thin layer of sealing material 28 is needed over the bonding region surface rather than a pool of material that would be required if a gravity-leveling potting compound were used.

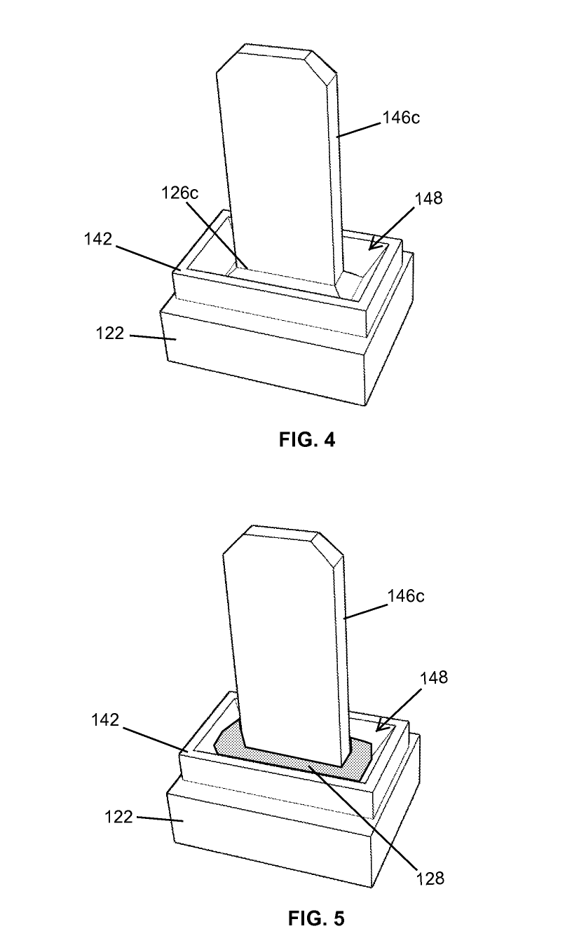

Optionally, the sealing function may be further enhanced by molding collars or moats into a housing 22 at the locations where leadframes 24a-24c exit housing 22 and into which conformal coating sealing material 28 may be applied. FIGS. 4 and 5 show an example of such a collar 142 formed in the inner surface 142 of housing 122 about insert tab 146. Collar 142 provides a channel or groove 148 in which sealing material 28 may collect, helping to form a continuous bead of sealing material at bonding region 126c. As shown, housing 122 includes a wall adjacent to and surrounding leadframe 46c into which conformal coating material 128 is disposed. It should be appreciated that housing 122 is only partially illustrated in FIG. 4 and that housing 122 may include multiple leadframes, including alternatively shaped, configured and located leadframes in like manner to housing 22 shown in FIG. 1. Still further, although collar 148 is shown in the illustrated embodiment as formed by a rectangular wall, it should be further appreciated that alternatively shaped and configured collars may be employed for receiving conformal coating material.

Optionally, the application of sealing material 28 and its sealing function may be further assisted by the application of a vacuum pressure (or a pressure below ambient pressure) on an underside 44 of connector 20 to create a pressure differential that draws sealing material 28 into bonding regions 26a-26c over and above what capillary action already promotes. In such a process, after or while conformal coating material is applied at bonding regions 26a-26c, housing 22 may be held by and sealed against a fixture (not shown) with a vacuum being applied to the side of housing 22 opposite to that from which leadframes 24a-24c project to thereby aid in drawing the conformal coating material therein.

As understood from FIG. 2, housing 22 is molded about leadframes 24a-24c such that the location at which leadframes 24a-24c exit or protrude from housing 22 have differing vertical heights or elevations from one another relative to the axial orientation of the distal ends of tabs 46a-46c that connect with an electronics assembly. The use of a conformal coating sealing material 28 having a tuned viscous property to inhibit flow under gravitational forces and the application of the material 28 at the bonding joints 26a-26c thereby enables the use of a significantly reduced volume of sealing material. For example, conventional electronics sealing potting compound has a low viscosity and flows readily under gravity whereby a significant volume of potting compound would be required to seal the various bonding joints 26a-26c of connector 20 as the conventional potting compound is gravity leveled and an amount sufficient to seal the highest vertically elevated bonding joint would be required, including the surrounding volumes. Moreover, the housing itself would have to be constructed or formed to include a tub, such as by way of an upstanding wall about the electronics side of the connector into which the potting compound can be poured.

Conformal coating materials are conventionally used on printed circuit boards, and can be acrylic, epoxy, urethane, paraxylylene or silicone based. In the preferred embodiment, the conformal coating sealing material 28 used is Dow Corning 3-1953 conformal coating provided by the Dow Corning Corp. of Midland, Mich. because of, for example, its compatibility with and ability to adhere to both metal and plastic, as well as its operating temperature range and its viscosity, which allows the material to be dispensed in a controllable manner around the inserts and sufficiently inhibits the material from flowing under the influence of gravity. Dow Corning 3-1953 has a viscosity of 400 mPa s, and a dynamic viscosity of 350 mPa s. However, other materials capable of bonding to both the housing and insert materials and having viscous properties that sufficiently limit or inhibit the movement of the sealing material while connector 20 is processed and the sealing material cures could alternatively be used.

Therefore, the present invention provides a sealed insert molded connector and method of sealing the same. A sealing material having viscous properties that allow the material to remain substantially in the region of application is used to create a moisture resistant seal between the inserts and the molded housing. Because the sealing material experiences low travel in response to gravitational forces, a thinner layer of the sealing material may be applied directly to the region of interest, reducing the amount of material needed for the sealing operation.

Changes and modifications to the specifically described embodiments may be carried out without departing from the principles of the present invention, which is intended to be limited only by the scope of the appended claims as interpreted according to the principles of patent law.

1. A sealed electronic connector comprising:
an insert;
a housing molded around said insert with a portion of said insert protruding from said housing; and
a sealing material applied where said insert protrudes from said housing, wherein said sealing material adheres to said insert and said housing.

2. The sealed electronic connector of claim 1, wherein said sealing material creates a moisture resistant seal between said insert and said housing.

3. The sealed electronic connector of claim 1, wherein said sealing material has viscous properties tuned to substantially inhibit said sealing material from flowing under the influence of gravity.

4. The sealed electronic connector of claim 1, wherein said sealing material is a conformal coating material.

5. The sealed electronic connector of claim 1, further comprising a collar in said housing around said insert wherein said collar allows said sealing material to collect.

6. The sealed electronic connector of claim 5, wherein said collar comprises an upstanding wall adjacent to and surrounding said insert.

7. The sealed electronic connector of claim 6, wherein said connector includes a plurality of inserts and wherein at least one said insert protrudes from said housing at an alternative relative elevation from another said insert.

8. A method of sealing an electronic connector having an insert molded into a housing and wherein a portion of said insert protrudes from said housing, the method comprising applying a sealing material where said insert protrudes from said housing.

9. The method of claim 8, wherein said sealing material has viscous properties tuned to generally prevent said sealing material from flowing under the influence of gravity.

10. The method of claim 8, wherein said sealing material is a conformal coating material.

11. The method of claim 10, wherein said sealing material is a room temperature vulcanizing conformal coating material.

12. The method of claim 8, further comprising applying a pressure differential to said connector to draw said sealing material between said insert and said housing.

13. The method of claim 8, wherein said sealing material is disposed in the form of a bead about said insert.

14. A method of forming an electronic connector, said method comprising:
molding a thermoplastic casing about a leadframe such that a portion of said leadframe extends from said casing, said leadframe extending from said casing to form a joint disposed about said leadframe;
applying a conformal coating material at said joint to seal said joint to inhibit egress of moisture there by.

15. The method of claim 14, wherein said molding a thermoplastic casing about a leadframe comprises forming a collar at said joint about said leadframe, and wherein said applying a conformal coating material comprises applying said conformal coating material in said collar.

16. The method of claim 14, wherein said molding a thermoplastic casing comprises molding a thermoplastic casing about a plurality of leadframes such that a portion of said leadframes extend from said casing to form joints disposed about said leadframes, and said applying a conformal coating material comprises applying a conformal coating material at a plurality of said joints.

17. The method of claim 16, wherein at least one said insert protrudes from said housing at an alternative relative elevation from another said insert.

18. The method of claim 14, further comprising applying a pressure differential to said connector to draw said sealing material between said joint and said leadframe.

19. The method of claim 14, wherein said applying a conformal coating material at said joint comprises applying a conformal coating material in the form of a bead surrounding said leadframe.
